(19) United States
(12) Patent Application Publication
(10) Pub. No.: US 2015/0078688 A1
(43) Pub. Date: Mar. 19, 2015

(54) BEARING ARRANGEMENT FOR ROLLING MILL ROLL SHAFT

(71) Applicants: William Xiaolan Shen, Boylston, MA (US); Keith E. Fiorucci, Sturbridge, MA (US)

(72) Inventors: William Xiaolan Shen, Boylston, MA (US); Keith E. Fiorucci, Sturbridge, MA (US)

(73) Assignee: Siemens Industry, Inc., Alpharetta, GA (US)

(21) Appl. No.: 14/025,937

(22) Filed: Sep. 13, 2013

(51) Int. Cl. F16C 41/00; F16C 32/06

(52) U.S. Cl. CPC F16C 41/00; F16C 32/0629; F16C 32/064
USPC 384/114

(57) ABSTRACT

A bearing arrangement comprises first and second axially spaced oil film bearings rotatably supporting a rolling mill roll shaft. An annular pressure plate is carried by and fixed relative to the roll shaft for rotation therewith. Third and fourth oil film bearings act on opposite sides of the pressure plate to axially fix the roll shaft.

### BACKGROUND

1. Field

Embodiments of the present invention relate to bearing arrangements for rotatably supporting roll shafts in a rolling mill. The invention is particularly suited for, although not limited in use to, high speed rolling mills having so called “cantilevered” roll shafts with axially projecting ends adapted to carry the work rolls.

2. Description of Related Art

As herein employed, “oil film bearing” means a bearing in which the rotating element is supported on a film of oil. “Hydrodynamic bearing” means an oil film bearing which relies on the high speed of the rotating element to pressurize the oil in a wedge-shaped film at the bearing load zone. “Hydrostatic bearing” means an oil film bearing which employs a positive pressure supply of oil to maintain a clearance between the rotating and stationary elements.

In a conventional high speed rolling mill, as depicted in FIG. 1, the roll shafts 10 are rotatably supported between first and second axially spaced radial bearings 12a, 12b. Radial bearings 12a are located inboard of axially projecting first ends 10a of the roll shafts, and radial bearing 12b are located inboard of axially projecting second ends 10b of the roll shafts. Work rolls 14 are carried on axially projecting first ends 10a of the roll shafts, and third and fourth thrust bearings 16a, 16b on the second shaft ends 10b serve to fix the roll shafts in the axial direction. The radial bearings may be oil film bearings, and may typically comprise hydrodynamic bearings, with the thrust bearings comprising angular ball bearings.

In addition to having a limited useful life, thrust ball bearings have been found to lack the stiffness required to provide axial precision for the rolling operation. While radial hydrodynamic bearings operate satisfactorily, they have been found to compromise radial precision because the thickness of the oil films supporting the rolls varies in response varying bearing loads.

### SUMMARY

Broadly stated, embodiments of the present invention address the above described problems by providing an improved bearing arrangement in which both the radial and thrust bearings are oil film bearings.

In exemplary embodiments of the present invention, the thrust bearings may be hydrodynamic bearings, but preferably will comprise hydrostatic bearings. Similarly, although the radial bearings may be hydrodynamic bearings, hydrostatic bearings are preferable.

Optimum stiffness is achieved by employing hydrostatic bearings for both the radial and thrust applications.

These and other features and advantages of present invention will become more apparent upon reading the following detailed description in conjunction with the accompanying drawings.

### BRIEF DESCRIPTION OF THE DRAWINGS

FIG. 1 is a sectional view through a roll stand employing a conventional bearing arrangement; and;

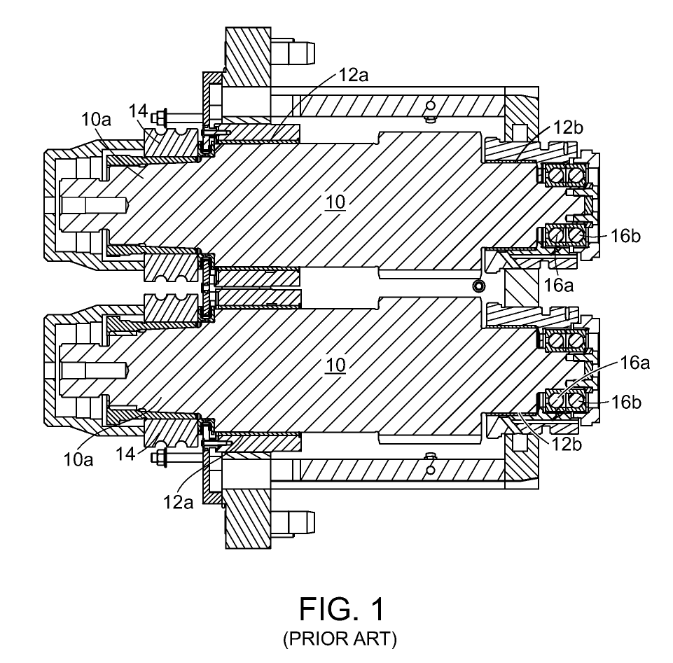

FIG. 2 is a sectional view through a roll stand employing a bearing arrangement in accordance with an exemplary embodiment of the present arrangement.

### DETAILED DESCRIPTION

The components described hereinafter as making up the various embodiments are intended to be illustrative and not restrictive. Many suitable components that would perform the same or a similar function as well as the materials described herein are intended to be embraced within the scope of embodiments of the present invention.

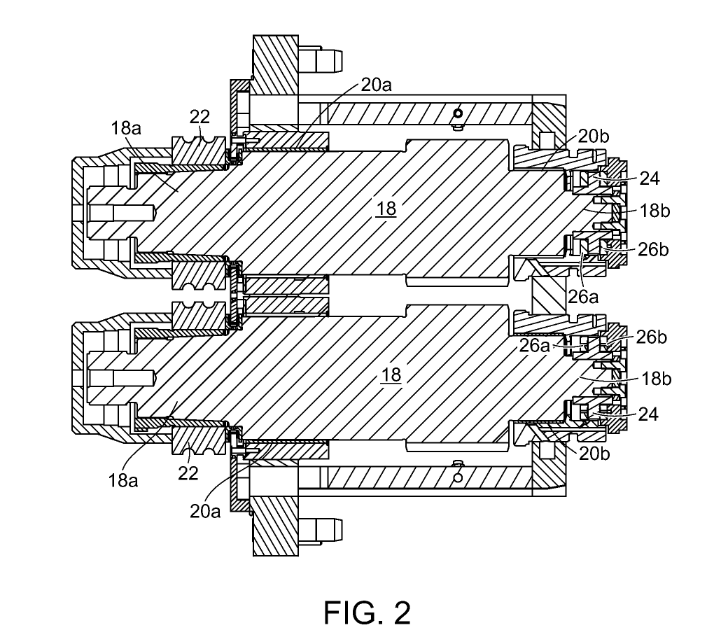

In accordance with exemplary embodiments of the present invention, as depicted in FIG. 2, the roll shafts 18 are rotatably supported by axially spaced first and second radial bearings 20a, 20b respectively located inboard of axially projecting first and second shaft ends 18a, 18b. Work rolls 22 are carried on the first shaft ends 18a and annular pressure plates 24 are mounted on and fixed relative to the second shaft ends 18b. Third and fourth thrust bearings 26a, 26b act on opposite sides of the pressure plates 24 to axially fix the roll shafts.

The first and second radial bearings 20a, 20b may be hydrodynamic bearings, but hydrostatic bearings are preferred. Similarly, although the third and fourth thrust bearings 26a, 26b may be hydrodynamic bearings, hydrostatic bearings are again preferred. Maximum stiffness is achieved by employing hydrostatic bearings for the first and second radial bearings 20a, 20b and the third and fourth thrust bearings 26a, 26b.

It is to be understood that while preferred embodiments of the present invention have been described, such embodiments should be considered as illustrative and may be modified by those skilled in the art without departing from the scope of the present invention, as defined by the appended claims.

What is claimed is:

1. A bearing arrangement for a rolling mill roll shaft, comprising:
first and second axially spaced oil film bearings rotatably supporting said roll shaft;
an annular pressure plate carried by and fixed relative to said roll shaft for rotation therewith; and
third and fourth oil film bearings acting on opposite sides of said pressure plate to axially fix said roll shaft.

2. The bearing arrangement of claim 1 wherein said first and second oil film bearings are hydrodynamic bearings.

3. The bearing arrangement of claim 1 wherein said first and second oil film bearings are hydrostatic bearings.

4. The bearing arrangement of claim 1 wherein said third and fourth oil film bearings are hydrodynamic bearings.

5. The bearing arrangement of claim 1 wherein said third and fourth oil film bearings are hydrostatic bearings.

6. The bearing arrangement of claim 1 wherein said first, second, third and fourth oil film bearings are hydrodynamic bearings.

7. The bearing arrangement of claim 1 wherein said first, second, third and fourth oil film bearings are hydrostatic bearings.

8. The bearing arrangement of claim 1 wherein said first oil film bearing is positioned inboard of an axially projecting first end of said roll shaft, said first roll shaft end being adapted to carry a work roll.

9. The bearing arrangement of claim 1 wherein said second oil film bearing is positioned inboard of an axially projecting second end of said roll shaft, and wherein said annular pressure plate is mounted on said second roll shaft end.

10. A bearing arrangement for a rolling mill roll shaft, comprising.
first and second hydrostatic bearings rotatably supporting said roll shaft at axially spaced locations respectively located inboard of first and second axially projecting roll ends, said first roll ends being adapted to carry work rolls;
an annular pressure plate mounted on and fixed relative to said second roll end; and
third and fourth hydrostatic bearings acting on opposite sides of said pressure plate to axially fix said roll shaft.
